(19) United States
(12) Patent Application Publication
(10) Pub. No.: US 2025/0218332 A1
(43) Pub. Date: Jul. 3, 2025

(54) METHOD FOR DRIVING DISPLAY PANEL AND DISPLAY DEVICE

(71) Applicant: TCL CHINA STAR OPTOELECTRONICS TECHNOLOGY CO., LTD., Shenzhen (CN)

(72) Inventors: Qian WANG, Shenzhen (CN); Jianmin NIE, Shenzhen (CN); Chaoping LI, Shenzhen (CN); Xingwu MA, Shenzhen (CN); Guanxian HE, Shenzhen (CN)

(21) Appl. No.: 18/617,151

(22) Filed: Mar. 26, 2024

(30) Foreign Application Priority Data
Dec. 27, 2023 (CN) 202311820806.0

(51) Int. Cl. G09G 3/20

(52) U.S. Cl. CPC G09G 3/2092; G09G 2310/08; G09G 2340/0435

(57) ABSTRACT

A display panel driving method. The method includes receiving a first video signal having a first frame rate; generating a second video signal having a second frame rate from the first video signal; driving the display panel to display an image according to the second video signal; a (2i-1)th frame of second image data of the second video signal includes first-type of row image data of an i-th frame of first image data of the first video signal, the 2i-th frame of the second image data includes second-type of row image data of the i-th frame of the first image data, a (2i+1)th frame of the second image data includes the second-type of row image data of an (i+1)th frame of the first image data, and a (2i+2)th frame of the second image data includes the first-type of row image data of the (i+1)th frame of the first image data.

### CROSS-REFERENCE TO RELATED APPLICATION

This application claims priority to and the benefit of Chinese Patent Application No. 202311820806.0, filed on Dec. 27, 2023, the disclosure of which is incorporated herein by reference in its entirety.

### TECHNICAL FIELD

The present disclosure relates to the field of display technology, and more particularly, to a method for driving a display panel and a display device.

### BACKGROUND

In the display technology of interlaced scanning under a frequency multiplication mode, the screen(s) displayed by the sub-pixels in odd-numbered rows and the screen(s) displayed by the sub-pixels in even-numbered rows in the display device are staggered and superimposed for a period of time, so that human eyes are susceptible to the phenomenon of fishbone-shaped misalignment occurring in the screen(s).

### SUMMARY

The present disclosure provides a method for driving a display panel and a display device to improve the phenomenon of fishbone-shaped misalignment occurring in the display technology of interlaced scanning under a frequency multiplication mode.

According to a first aspect, the present disclosure provides a method for driving a display panel. The method includes: receiving a first video signal having a first frame rate; generating a second video signal having a second frame rate from the first video signal, wherein the second frame rate is greater than the first frame rate; driving the display panel to display an image according to the second video signal; wherein the first video signal includes N frames of first image data to be continuously displayed, the second video signal includes 2N frames of second image data to be continuously displayed, a (2i−1)th frame of the second image data in the 2N frames of the second image data includes a first-type of row image data of an i-th frame of the first image data, a 2i-th frame of the second image data in the 2N frames of the second image data includes a second-type of row image data of the i-th frame of the first image data, a (2i+1)th frame of the second image data in the 2N frames of the second image data includes the second-type of row image data of an (i+1)th frame of the first image data, and a (2i+2)th frame of the second image data in the 2N frames of the second image data includes the first-type of row image data of the (i+1)th frame of the first image data; the first-type of row image data being one of odd-numbered row image data and even-numbered row image data, the second-type of row image data being another one of the odd-numbered row image data and the even-numbered row image data, N being an integer greater than or equal to 2, i=m*j+1, with i being less than N, m being an integer greater than or equal to 2, and j being an integer greater than or equal to 0.

According to a second aspect, the present disclosure provides a display device including a display panel and a control chip electrically connected to the display panel. The control chip is configured to drive the display panel to display an image according to the method for driving a display panel as described above.

### BRIEF DESCRIPTION OF THE DRAWINGS

FIG. 1 is a schematic diagram showing how a display device performs a frequency multiplication operation in the related art.

FIG. 2 is a timing diagram of a scan signal output by a scan driver in the related art.

FIG. 3 is a schematic representation of the phenomenon of fishbone-shaped misalignment occurring in the related art.

FIG. 4 is a schematic diagram showing how a control chip processes image data in a method for driving a display panel according to the present disclosure.

FIG. 5 is a timing diagram of a scan signal output by a scan driver in a method for driving a display panel according to the present disclosure.

FIG. 6 is a block diagram of a display device according to the present disclosure.

### DETAILED DESCRIPTION

The technical solution in the embodiments of the present disclosure will be described below in connection with the accompanying drawings in the embodiments of the present disclosure. The technical solution described below is solely for the purpose of explanation and description of the idea of the present disclosure, and should not be construed as limiting the scope of protection of the present disclosure.

Furthermore, the terms “first”, “second”, and the like do not denote any order, number, or importance, but rather are used to distinguish between different technical features. The terms “a plurality of” and the like denote two or more unless expressly defined otherwise.

The present disclosure provides a method for driving a display panel which includes the following steps.
Receiving a first video signal having a first frame rate;
Generating a second video signal having a second frame rate from the first video signal, wherein the second frame rate is greater than the first frame rate;
Driving the display panel to display an image according to the second video signal;
The first video signal includes N frames of first image data to be continuously displayed, the second video signal includes 2N frames of second image data to be continuously displayed, a (2i−1)th frame of the second image data in the 2N frames of the second image data includes a first-type of row image data of an i-th frame of the first image data, a 2i-th frame of the second image data in the 2N frames of the second image data includes a second-type of row image data of the i-th frame of the first image data, a (2i+1)th frame of the second image data in the 2N frames of the second image data includes the second-type of row image data of an (i+1)th frame of the first image data, and a (2i+2)th frame of the second image data in the 2N frames of the second image data includes the first-type of row image data of the (i+1)th frame of the first image data.

The first-type of row image data is one of odd-numbered row image data and even-numbered row image data, and the second-type of row image data is another one of the odd-numbered row image data and the even-numbered row image data. N is an integer greater than or equal to 2, i−m*j+1, with i being less than N, m being an integer greater than or equal to 2, and j being an integer greater than or equal to 0.

Wherein, i is 1, 3, 4, 5, 7, 9, or the like.

In the case of m=2, i=2j+1, at this point, i is an odd number. A plurality of the first-type of row image data and a plurality of the second-type of row image data are arranged in a specific order with a drive cycle of four image frames.

The first video signal includes a first frame of the first image data and a second frame of the first image data to be continuously displayed, and the second video signal includes a first frame of the second image data, a second frame of the second image data, a third frame of the second image data, and a fourth frame of the second image data to be continuously displayed.

The first frame of the second image data includes the first-type of row image data of the first frame of the first image data, the second frame of the second image data includes the second-type of row image data of the first frame of the first image data, the third frame of the second image data includes the second-type of row image data of the second frame of the first image data, and the fourth frame of the second image data includes the first-type of row image data of the second frame of the first image data.

The generating a second video signal having a second frame rate from the first video signal includes:

Generating the first frame of the second image data from the first-type of row image data in the first frame of the first image data of the first video signal.

Generating the second frame of the second image data from the second-type of row image data in the first frame of the first image data.

Generating the third frame of the second image data from the second-type of row image data in the second frame of the first image data to be continuously displayed with the first frame of the first image data in the first video signal.

Generating the fourth frame of the second image data from the first-type of row image data in the second frame of the first image data.

Generating the second video signal from the first frame of the second image data, the second frame of the second image data, the third frame of the second image data, and the fourth frame of the second image data to be continuously displayed.

The first video signal further includes a third frame of the first image data to be continuously displayed with the second frame of the first image data and a fourth frame of the first image data to be continuously displayed with the third frame of the first image data, and the second video signal further includes a fifth frame of the second image data, a sixth frame of the second image data, a seventh frame of the second image data and an eighth frame of the second image data to be continuously displayed, wherein the fifth frame of the second image data is image data to be continuously displayed with the fourth frame of the second image data.

The fifth frame of the second image data includes the first-type of row image data of the third frame of the first image data, the sixth frame of the second image data includes the second-type of row image data of the third frame of the first image data, the seventh frame of the second image data includes the second-type of row image data of the fourth frame of the first image data, and the eighth frame of the second image data includes the first-type of row image data of the fourth frame of the first image data.

The generating a second video signal having a second frame rate from the first video signal further includes:

Generating the fifth frame of the second image data from the first-type of row image data in the third frame of the first image data continuously displayed with the second frame of the first image data in the second video signal.

Generating the sixth frame of the second image data from the second-type of row image data in the third frame of the first image data.

Generating the seventh frame of the second image data from the second-type of row image data in the fourth frame of the first image data continuously displayed with the third frame of the first image data in the second video signal.

Generating the eighth frame of the second image data from the first-type of row image data in the fourth frame of the first image data.

Generating the second video signal from the fifth frame of the second image data, the sixth frame of the second image data, the seventh frame of the second image data, and the eighth frame of the second image data to be continuously displayed.

In the case of m=3 and j=1, i=3*1+1, at this point, i is 4. A plurality of the first-type of row image data and a plurality of the second-type of row image data are arranged in a specific order with a drive cycle of six image frames.

A (2i+3)th frame of the second image data in the 2N frames of the second image data includes the first-type of row image data of a (i+2)th frame of the first image data, and a (2i+4)th frame of the second image data in the 2N frames of the second image data includes the second-type of row image data of the (i+2)th frame of the first image data.

The first video signal includes a first frame of the first image data, a second frame of the first image data, and a third frame of the first image data to be continuously displayed, and the second video signal includes a first frame of the second image data, a second frame of the second image data, a third frame of the second image data, a fourth frame of the second image data, a fifth frame of the second image data, and a sixth frame of the second image data to be continuously displayed.

The first frame of the second image data includes the first-type of row image data of the first frame of the first image data, the second frame of the second image data includes the second-type of row image data of the first frame of the first image data, the third frame of the second image data includes the second-type of row image data of the second frame of the first image data, the fourth frame of the second image data includes the first-type of row image data of the second frame of the first image data, the fifth frame of the second image data includes the first-type of row image data of the third frame of the first image data, and the sixth frame of the second image data includes the second-type of row image data of the third frame of the first image data.

The generating a second video signal having a second frame rate from the first video signal includes the steps of:

Generating the first frame of the second image data from the first-type of row image data in the first frame of the first image data of the first video signal.

Generating the second frame of the second image data from the second-type of row image data in the first frame of the first image data.

Generating the third frame of the second image data from the second-type of row image data in the second frame of the first image data of the first video signal.

Generating the fourth frame of the second image data from the first-type of row image data in the second frame of the first image data.

Generating the fifth frame of the second image data from the first-type of row image data in the third frame of the first image data of the first video signal.

Generating the sixth frame of the second image data from the second-type of row image data in the third frame of the first image data.

Generating the second video signal from the first frame of the second image data, the second frame of the second image data, the third frame of the second image data, the fourth frame of the second image data, the fifth frame of the second image data, and the sixth frame of the second image data to be continuously displayed.

The first video signal includes the fourth frame of the first image data, a fifth frame of the first image data, and a sixth frame of the first image data to be continuously displayed, the fourth frame of the first image data is image data to be continuously displayed with the third frame of the first image data, the second video signal includes a seventh frame of the second image data, an eighth frame of the second image data, a ninth frame of the second image data, a tenth frame of the second image data, an eleventh frame of the second image data, and a twelfth frame of the second image data to be continuously displayed, and the seventh frame of the second image data is image data to be continuously displayed with the sixth frame of the second image data.

The seventh frame of the second image data includes the first-type of row image data of the fourth frame of the first image data, the eighth frame of the second image data includes the second-type of row image data of the fourth frame of the first image data, the ninth frame of the second image data includes the second-type of row image data of the fifth frame of the first image data, the tenth frame of the second image data includes the first-type of row image data of the fifth frame of the first image data, the eleventh frame of the second image data includes the first-type of row image data of the sixth frame of the first image data, and the twelfth frame of the second image data includes the second-type of row image data of the sixth frame of the first image data.

The generating a second video signal having a second frame rate from the first video signal further includes the steps of:

Generating the seventh frame of the second image data from the first-type of row image data in the fourth frame of the first image data of the first video signal.

Generating the eighth frame of the second image data from the second-type of row image data in the fourth frame of the first image data.

Generating the ninth frame of the second image data from the second-type of row image data in the fifth frame of the first image data of the first video signal.

Generating the tenth frame of the second image data from the first-type of row image data in the fifth frame of the first image data.

Generating the eleventh frame of the second image data from the first-type of row image data in the sixth frame of the first image data of the first video signal.

Generating the twelfth frame of the second image data from the second-type of row image data in the sixth frame of the first image data.

Generating the second video signal from the seventh frame of the second image data, the eighth frame of the second image data, the ninth frame of the second image data, the tenth frame of the second image data, the eleventh frame of the second image data, and the twelfth frame of the second image data to be continuously displayed.

In the case of m=3 and j=1, i=3*1+1, at this point, i is 4. A plurality of the first-type of row image data and a plurality of the second-type of row image data are arranged in a specific order with a drive cycle of six image frames.

A (2i+3)th frame of the second image data in the 2N frames of the second image data includes the second-type of row image data of a (i+2)th frame of the first image data, and a (2i+4)th frame of the second image data in the 2N frames of the second image data includes the first-type of row image data of the (i+2)th frame of the first image data.

The first video signal includes a first frame of the first image data, a second frame of the first image data, and a third frame of the first image data to be continuously displayed, and the second video signal includes a first frame of the second image data, a second frame of the second image data, a third frame of the second image data, a fourth frame of the second image data, a fifth frame of the second image data, and a sixth frame of the second image data to be continuously displayed.

The first frame of the second image data includes the first-type of row image data of the first frame of the first image data, the second frame of the second image data includes the second-type of row image data of the first frame of the first image data, the third frame of the second image data includes the second-type of row image data of the second frame of the first image data, the fourth frame of the second image data includes the first-type of row image data of the second frame of the first image data, the fifth frame of the second image data includes the second-type of row image data of the third frame of the first image data, and the sixth frame of the second image data includes the first-type of row image data of the third frame of the first image data.

The generating a second video signal having a second frame rate from the first video signal includes the steps of:

Generating the first frame of the second image data from the first-type of row image data in the first frame of the first image data of the first video signal.

Generating the second frame of the second image data from the second-type of row image data in the first frame of the first image data.

Generating the third frame of the second image data from the second-type of row image data in the second frame of the first image data of the first video signal.

Generating the fourth frame of the second image data from the first-type of row image data in the second frame of the first image data.

Generating the fifth frame of the second image data from the second-type of row image data in the third frame of the first image data of the first video signal.

Generating the sixth frame of the second image data from the first-type of row image data in the third frame of the first image data.

The first video signal includes a fourth frame of the first image data, a fifth frame of the first image data, and a sixth frame of the first image data to be continuously displayed, the fourth frame of the first image data is image data to be continuously displayed with the third frame of the first image data, the second video signal includes a seventh frame of the second image data, an eighth frame of the second image data, a ninth frame of the second image data, a tenth frame of the second image data, an eleventh frame of the second image data, and a twelfth frame of the second image data be continuously displayed, the seventh frame of the second image data is image data to be continuously displayed with the sixth frame of the second image data.

The seventh frame of the second image data includes the first-type of row image data of the fourth frame of the first image data, the eighth frame of the second image data includes the second-type of row image data of the fourth frame of the first image data, the ninth frame of the second image data includes the second-type of row image data of the fifth frame of the first image data, the tenth frame of the second image data includes the first-type of row image data of the fifth frame of the first image data, the eleventh frame of the second image data includes the second-type of row image data of the sixth frame of the first image data, and the twelfth frame of the second image data includes the first-type of row image data of the sixth frame of the first image data.

The generating a second video signal having a second frame rate from the first video signal further includes the steps of:

Generating the seventh frame of the second image data from the first-type of row image data in the fourth frame of the first image data of the first video signal.

Generating the eighth frame of the second image data from the second-type of row image data in the fourth frame of the first image data.

Generating the ninth frame of the second image data from the second-type of row image data in the fifth frame of the first image data of the first video signal.

Generating the tenth frame of the second image data from the first-type of row image data in the fifth frame of the first image data.

Generating the eleventh frame of the second image data from the second-type of row image data in the sixth frame of the first image data of the first video signal.

Generating the twelfth frame of the second image data from the first-type of row image data in the sixth frame of the first image data.

Generating the second video signal from the seventh frame of the second image data, the eighth frame of the second image data, the ninth frame of the second image data, the tenth frame of the second image data, the eleventh frame of the second image data, and the twelfth frame of the second image data to be continuously displayed.

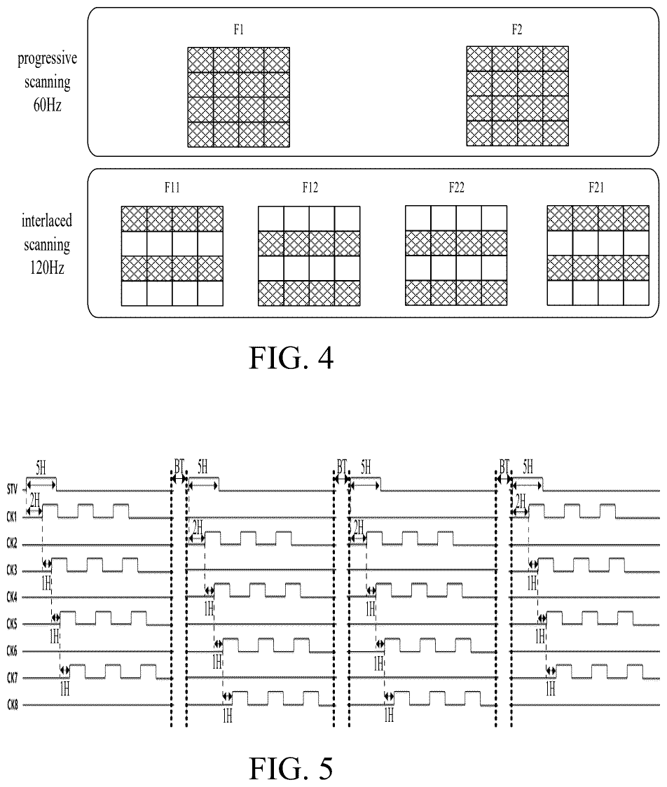

As shown in FIGS. 4 to 6, the present disclosure further provides a display device including a display panel 200 and a control chip 100 electrically connected to the display panel. The control chip is configured to drive the display panel to display an image according to the method(s) for driving a display panel as described above.

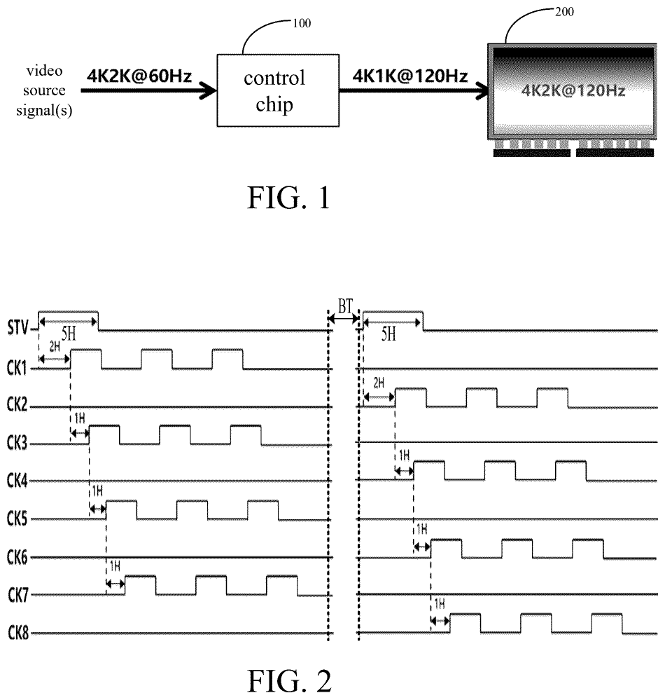

As shown in FIG. 1, a system chip/mainboard/control chip (System on Chip, SoC) 100 receives a video source signal (first video signal) of 4K2K@60 Hz (4K2K is the image resolution, 4K is the number of columns in the image resolution, 2K is the number of rows in the image resolution, and 60 Hz is the first frame rate), and the control chip 100 processes the video source signal into a second video signal of 4K1K@120 Hz (4K1K is the image resolution, 1K is the number of rows in the image resolution, and 120 Hz is the second frame rate), and the display panel 200 changes a refresh frequency from 60 Hz to 120 Hz, and displays an image of 4K2K@120 Hz (4K2K is the resolution, and 120 Hz is the second frame rate) according to the second video signal.

The control chip 100 splits any one frame of the first image data (F) in the first video signal having an image resolution of 4K2K into two frames of the second image data having an image resolution of 4K1K, namely, odd-numbered row sub-image data (FA) and even-numbered row sub-image data (FB).

Wherein the odd-numbered row sub-image data (FA) is image data of all odd-numbered rows in the first image data (F). The even-numbered row sub-image data (FB) is image data of all even-numbered rows in the first image data (F).

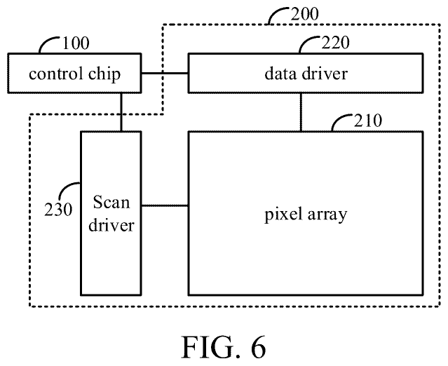

The control chip 100 controls the scan driver 230 of the display panel to turn on or off sub-pixels in odd-numbered rows and sub-pixels in even-numbered rows by means of drive mode of interlaced scanning, and writes the odd-numbered row sub-image data (FA) and the even-numbered row sub-image data (FB) into corresponding sub-pixels in the odd-numbered rows and corresponding sub-pixels in the even-numbered rows via the data driver 220 (see FIG. 6), respectively. Finally, the display panel displays the image data (F) 200 as an image of 4K2K@120 Hz.

The control chip 100 controls the scan driver 230 to realize the drive mode of interlaced scanning through a start control signal (STV) and clock signals CK1-CK8. The control chip 100 sequentially outputs pulses of the start control signal, the clock signal CK1, the clock signal CK3, the clock signal CK5, and the clock signal CK7, controls the scan driver 230 to sequentially turn on the corresponding sub-pixels in the odd-numbered rows, and controls the data driver to write the odd-numbered row sub-image data (FA) into the corresponding sub-pixels in the odd-numbered rows in a drive cycle of the odd-numbered row sub-image data. The control chip 100 sequentially outputs pulses of the start control signal, the clock signal CK2, the clock signal CK4, the clock signal CK6, and the clock signal CK8, controls the scan driver 230 to sequentially turn on the corresponding sub-pixels in the even-numbered rows, and controls the data driver to write the even-numbered row sub-image data (FB) into the corresponding sub-pixels in the even-numbered rows in a drive cycle of the even-numbered row sub-image data.

Wherein, there is an interval called blanking time (BT) between the drive cycle of the odd-numbered row sub-image data and the drive cycle of the even-numbered row sub-image data. A pulse width of the start control signal may be 5H.

In the drive cycle of the odd-numbered row sub-image data, a pulse rising edge of the start control signal is 2H earlier than a pulse rising edge of the clock signal CK1, the pulse rising edge of the clock signal CK1 is 1H earlier than a pulse rising edge of the clock signal CK3, the pulse rising edge of the clock signal CK3 is 1H earlier than a pulse rising edge of the clock signal CK5, and the pulse rising edge of the clock signal CK5 is 1H earlier than a pulse rising edge of the clock signal CK7. Wherein, His a unit time that may be adjusted according to the refresh frequency of the display panel.

In the drive cycle of the even-numbered row sub-image data, the pulse rising edge of the start control signal is 2H earlier than a pulse rising edge of the clock signal CK2, the pulse rising edge of the clock signal CK2 is 1H earlier than a pulse rising edge of the clock signal CK4, the pulse rising edge of the clock signal CK4 is 1H earlier than a pulse rising edge of the clock signal CK6, and the pulse rising edge of the clock signal CK6 is 1H earlier than a pulse rising edge of the clock signal CK8.

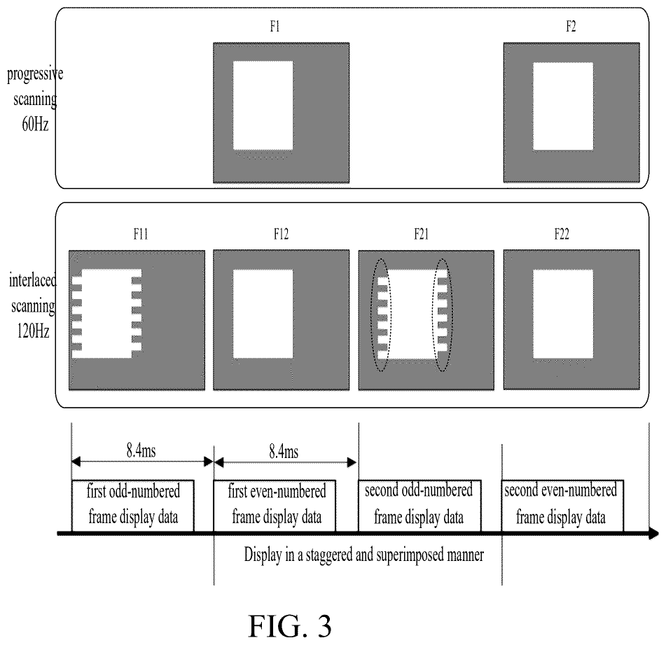

As shown in FIG. 3, in the 60 Hz refresh frequency mode, the solution in which the control chip 100 controls the display panel to display an image in a drive mode of progressive scanning is as follows: First, a first frame of first image data (F1) is displayed, and then a second frame of the first image data (F2) is displayed. Wherein, taking an image in which grey surrounds white as an example, the white square moves to the right over time, for example, the position of the white square in the second frame of image (F2) is further to the right than the position in the first frame of the first image data (F1). Wherein, pulse widths and intervals between pulses may be seen in FIG. 2.

In the 120 Hz refresh frequency mode (frequency multiplication), the solution in which the control chip 100 controls the display panel to display an image in a drive mode of interlaced scanning is as follows: Each original frame of first image data is split into odd-numbered row sub-image data and even-numbered row sub-image data. For example, a first frame image (F1) is split into a first odd-numbered row frame image (F11) corresponding to a first odd-numbered row sub-image data and a first even-numbered row frame image (F12) corresponding to a first even-numbered row sub-image data, and a second frame image (F2) is split into a second odd-numbered row frame image (F21) corresponding to a second odd-numbered row sub-image data and a second even-numbered row frame image (F22) corresponding to a second even-numbered row sub-image data.

As shown in FIGS. 4-6, the control chip 100 splits each frame of the first image data into one odd-numbered row sub-image data and one even-numbered row sub-image data, and controls the data driver to output the odd-numbered row sub-image data and the even-numbered row sub-image data of each frame of the first image data in a predetermined order. The predetermined order may be an order of odd-numbered row sub-image data, even-numbered row sub-image data, even-numbered row sub-image data, and odd-numbered row sub-image data in sequence. Of course, the predetermined order may also be an order of the even-numbered row sub-image data, the odd-numbered row sub-image data, the odd-numbered row sub-image data, and the even-numbered row sub-image data in sequence. The display panel 200 displays according to the order in which the odd-numbered row sub-image data and the even-numbered row sub-image data are output from the control chip 100. Therefore, it is possible to avoid a regularly staggered superposition phenomenon caused by the display panel displaying according to a fixed order of odd-numbered row sub-image data, even-numbered row sub-image data, odd-numbered row sub-image data, and even-numbered row sub-image data under a drive mode of interlaced scanning, thereby improving the phenomenon of fishbone-shaped misalignment occurring in the display technology of interlaced scanning under a frequency multiplication mode.

The odd-numbered row sub-image data is a set of image data of a number of odd-numbered rows in a frame of the first image data, and the even-numbered row sub-image data is a set of image data of a number of even-numbered rows in a frame of the first image data. This can be achieved by splitting the odd-numbered row image data and the even-numbered row image data in a frame of image data.

The present disclosure can avoid a regularly staggered superposition phenomenon caused by the display panel displaying according to a fixed order of odd-numbered row sub-image data, even-numbered row sub-image data, odd-numbered row sub-image data, and even-numbered row sub-image data under a drive mode of interlaced scanning by adjusting multiple frames of second image data that are continuously displayed (including at least two frames of odd-numbered row sub-image data and two frames of even-numbered row sub-image data), thereby improving the phenomenon of fishbone-shaped misalignment occurring in the display technology of interlaced scanning under a frequency multiplication mode.

Specifically, the present disclosure overcomes the problem that the display panel needs to wait for half a frame time to start displaying the next frame of odd-numbered row sub-image data after displaying the current frame of even-numbered row sub-image data, resulting in the phenomenon that two screens are interlaced and superimposed on the display panel, namely the fishbone-shaped misalignment phenomenon (as shown in the position circled by the ellipse (dashed line) in FIG. 3).

Wherein, at the 120 Hz refresh frequency, the half a frame time is about 8.4 ms.

As shown in FIG. 6, the display panel 200 includes a pixel array 210 including sub-pixels in odd-numbered rows and sub-pixels in even-numbered rows that are arranged alternately, a data driver 220, and a scan driver 230. The scan driver 230 controls odd-numbered row sub-image data and even-numbered row sub-image data to be written to corresponding sub-pixels in the odd-numbered rows and corresponding sub-pixels in the even-numbered rows, respectively, by a drive mode of interlaced scanning.

As shown in FIG. 5, the scan driver 230 may implement the drive mode of interlaced scanning under the control of a start control signal (STV) and clock signals CK1-CK8.

In a drive cycle of first odd-numbered row sub-image data, the control chip 100 sequentially outputs pulses of the start control signal, the clock signal CK1, the clock signal CK3, the clock signal CK5, and the clock signal CK7, controls the scan driver 230 to sequentially turn on the corresponding sub-pixels in the odd-numbered rows, and controls the data driver to write the first odd-numbered row sub-image data into the corresponding sub-pixels in the odd-numbered rows.

In a drive cycle of first even-numbered row sub-image data, the control chip 100 sequentially outputs pulses of the start control signal, the clock signal CK2, the clock signal CK4, the clock signal CK6, and the clock signal CK8, controls the scan driver 230 to sequentially turn on the corresponding sub-pixels in the even-numbered rows, and controls the data driver to write the first even-numbered row sub-image data into the corresponding sub-pixels in the even-numbered rows.

In a drive cycle of second even-numbered row sub-image data, the control chip 100 sequentially outputs pulses of the start control signal, the clock signal CK2, the clock signal CK4, the clock signal CK6, and the clock signal CK8, controls the scan driver 230 to sequentially turn on the corresponding sub-pixels in the even-numbered rows, and controls the data driver to write the second even-numbered row sub-image data into the corresponding sub-pixels in the even-numbered rows.

In a drive cycle of second odd-numbered row sub-image data, the control chip 100 sequentially outputs pulses of the start control signal, the clock signal CK1, the clock signal CK3, the clock signal CK5, and the clock signal CK7, controls the scan driver 230 to sequentially turn on the corresponding sub-pixels in the odd-numbered rows, and controls the data driver to write the second odd-numbered row sub-image data into the corresponding sub-pixels in the odd-numbered rows.

As an alternative, the control chip 100 sequentially outputs the first even-numbered row sub-image data, the first odd-numbered row sub-image data, the second odd-numbered row sub-image data, the second even-numbered row sub-image data, third odd-numbered row sub-image data, and third even-numbered row sub-image data to the display panel 200.

As an alternative, the control chip 100 sequentially outputs the first odd-numbered row sub-image data, the first even-numbered row sub-image data, the second even-numbered row sub-image data, the second odd-numbered row sub-image data, third odd-numbered row sub-image data, and third even-numbered row sub-image data to the display panel 200.

As an alternative, the control chip 100 sequentially outputs the first odd-numbered row sub-image data, the first even-numbered row sub-image data, the second odd-numbered row sub-image data, the second even-numbered row sub-image data, third even-numbered row sub-image data, and third odd-numbered row sub-image data to the display panel 200.

As an alternative, the control chip sequentially outputs the first odd-numbered row sub-image data, the first even-numbered row sub-image data, the second even-numbered row sub-image data, the second odd-numbered row sub-image data, third even-numbered row sub-image data, and third odd-numbered row sub-image data to the display panel 200.

As an alternative, the control chip 100 sequentially outputs the first odd-numbered row sub-image data, the first even-numbered row sub-image data, the second even-numbered row sub-image data, the second odd-numbered row sub-image data, third odd-numbered row sub-image data, and third even-numbered row sub-image data to the display panel 200.

As an alternative, the control chip 100 sequentially outputs the first even-numbered row sub-image data, the first odd-numbered row sub-image data, the second odd-numbered row sub-image data, the second even-numbered row sub-image data, third even-numbered row sub-image data, and third odd-numbered row sub-image data to the display panel 200.

The above alternatives can also avoid a regularly staggered superposition phenomenon caused by the display panel displaying according to a fixed order of odd-numbered row sub-image data, even-numbered row sub-image data, odd-numbered row sub-image data, and even-numbered row sub-image data under a drive mode of interlaced scanning, thereby improving the phenomenon of fishbone-shaped misalignment occurring in the display technology of interlaced scanning under a frequency multiplication mode.

The drive architecture of the display panel of the present disclosure may be, for example, a Tri-Gate drive architecture, a One Gate line One Data line (1G1D) drive architecture.

The above refresh frequencies are by way of example 60 Hz and 120 Hz. The present disclosure may also be applied to frequency multiplication modes with refresh frequencies of 240 Hz, 480 Hz or higher.

The method for driving a display panel and a display device provided by the present disclosure are described in detail above. It will be appreciated by those of ordinary skill in the art that modifications to the above-described technical solutions, or equivalents of some of the technical features thereof, do not depart from the nature of the corresponding technical solutions as claimed in the present disclosure.

The terms “comprises”, “comprising”, “includes”, “including”, “having” and their conjugates mean “including but not limited to”.

As used herein, the singular form “a”, “an” and “the” include plural references unless the context clearly dictates otherwise.

In addition, the terms “first”, “second”, etc. are used herein only to facilitate discussion, and have no specific temporal or chronological meaning unless otherwise stated.

Finally, it should be noted that: for those skilled in the art, it is obvious that the present disclosure is not limited to the details of the above-mentioned exemplary embodiments. Therefore, the embodiments should be regarded as exemplary and non-restrictive from any point of view, and the scope of the present disclosure is defined by the appended claims rather than by the above description, and it is therefore intended that all changes that fall within the meaning and scope of equivalent elements of the claims are included in the present disclosure. Any reference sign in a claim should not be construed as limiting the claim concerned. In addition, it is obvious that the word “comprising/including” does not exclude other elements or steps, and the singular forms do not exclude the plural forms. The plurality of units or devices stated in the system claims may also be implemented by one unit or device through software or hardware. Words such as first, second, etc. are used to denote names and do not denote any particular order. The application of the present disclosure is not limited to the above-described examples, and it is still possible to modify the technical solutions recited in the aforementioned embodiments or to make equivalent substitutions for some of the technical features therein. Those skilled in the art will understand from the preceding description that a wide range of techniques for implementing the various embodiments of the present disclosure can be implemented in various forms. Thus, although the various embodiments of the present disclosure are described in connection with their particular examples, the true scope of the various embodiments of the present disclosure should not be limited in this way, as other modifications will become apparent to the skilled practitioner after studying the accompanying drawings, the specification, and the appended claims.

What is claimed is:

1. A method for driving a display panel, comprising:
receiving a first video signal having a first frame rate;
generating a second video signal having a second frame rate from the first video signal, wherein the second frame rate is greater than the first frame rate;
driving the display panel to display an image according to the second video signal;
wherein the first video signal comprises N frames of first image data to be continuously displayed, the second video signal comprises 2N frames of second image data to be continuously displayed, a (2i−1)th frame of the second image data in the 2N frames of the second image data comprises a first-type of row image data of an i-th frame of the first image data, a 2i-th frame of the second image data in the 2N frames of the second image data comprises a second-type of row image data of the i-th frame of the first image data, a (2i+1)th frame of the second image data in the 2N frames of the second image data comprises the second-type of row image data of an (i+1)th frame of the first image data, and a (2i+2)th frame of the second image data in the 2N frames of the second image data comprises the first-type of row image data of the (i+1)th frame of the first image data;
the first-type of row image data is one of odd-numbered row image data and even-numbered row image data, and the second-type of row image data is another one of the odd-numbered row image data and the even-numbered row image data, N is an integer greater than or equal to 2, i=m*j+1, with i being less than N, m being an integer greater than or equal to 2, and j being an integer greater than or equal to 0.

2. The method for driving a display panel according to claim 1, wherein m=2;
the first video signal comprises a first frame of the first image data and a second frame of the first image data to be continuously displayed, and the second video signal comprises a first frame of the second image data, a second frame of the second image data, a third frame of the second image data, and a fourth frame of the second image data to be continuously displayed;
the first frame of the second image data comprises the first-type of row image data of the first frame of the first image data, the second frame of the second image data comprises the second-type of row image data of the first frame of the first image data, the third frame of the second image data comprises the second-type of row image data of the second frame of the first image data, and the fourth frame of the second image data comprises the first-type of row image data of the second frame of the first image data.

3. The method for driving a display panel according to claim 2, wherein the generating a second video signal having a second frame rate from the first video signal comprises:
generating the first frame of the second image data from the first-type of row image data in the first frame of the first image data of the first video signal;
generating the second frame of the second image data from the second-type of row image data in the first frame of the first image data;
generating the third frame of the second image data from the second-type of row image data in the second frame of the first image data to be continuously displayed with the first frame of the first image data in the first video signal;
generating the fourth frame of the second image data from the first-type of row image data in the second frame of the first image data.

4. The method for driving a display panel according to claim 1, wherein m=3;
a (2i+3)th frame of the second image data in the 2N frames of the second image data comprises the first-type of row image data of a (i+2)th frame of the first image data, and a (2i+4)th frame of the second image data in the 2N frames of the second image data comprises the second-type of row image data of the (i+2)th frame of the first image data.

5. The method for driving a display panel according to claim 4, wherein the first video signal comprises a first frame of the first image data, a second frame of the first image data, and a third frame of the first image data to be continuously displayed, and the second video signal comprises a first frame of the second image data, a second frame of the second image data, a third frame of the second image data, a fourth frame of the second image data, a fifth frame of the second image data, and a sixth frame of the second image data to be continuously displayed;
the first frame of the second image data comprises the first-type of row image data of the first frame of the first image data, the second frame of the second image data comprises the second-type of row image data of the first frame of the first image data, the third frame of the second image data comprises the second-type of row image data of the second frame of the first image data, the fourth frame of the second image data comprises the first-type of row image data of the second frame of the first image data, the fifth frame of the second image data comprises the first-type of row image data of the third frame of the first image data, and the sixth frame of the second image data comprises the second-type of row image data of the third frame of the first image data.

6. The method for driving a display panel according to claim 5, wherein the generating a second video signal having a second frame rate from the first video signal comprises:
generating the first frame of the second image data from the first-type of row image data in the first frame of the first image data of the first video signal;
generating the second frame of the second image data from the second-type of row image data in the first frame of the first image data;
generating the third frame of the second image data from the second-type of row image data in the second frame of the first image data of the first video signal;
generating the fourth frame of the second image data from the first-type of row image data in the second frame of the first image data;
generating the fifth frame of the second image data from the first-type of row image data in the third frame of the first image data of the first video signal;
generating the sixth frame of the second image data from the second-type of row image data in the third frame of the first image data.

7. The method for driving a display panel according to claim 1, wherein m=3;
a (2i+3)th frame of the second image data in the 2N frames of the second image data comprises the second-type of row image data of a (i+2)th frame of the first image data, and a (2i+4)th frame of the second image data in the 2N frames of the second image data comprises the first-type of row image data of the (i+2)th frame of the first image data.

8. The method for driving a display panel according to claim 7, wherein the first video signal comprises a first frame of the first image data, a second frame of the first image data, and a third frame of the first image data to be continuously displayed, and the second video signal comprises a first frame of the second image data, a second frame of the second image data, a third frame of the second image data, a fourth frame of the second image data, a fifth frame of the second image data, and a sixth frame of the second image data to be continuously displayed;
the first frame of the second image data comprises the first-type of row image data of the first frame of the first image data, the second frame of the second image data comprises the second-type of row image data of the first frame of the first image data, the third frame of the second image data comprises the second-type of row image data of the second frame of the first image data, the fourth frame of the second image data comprises the first-type of row image data of the second frame of the first image data, the fifth frame of the second image data comprises the second-type of row image data of the third frame of the first image data, and the sixth frame of the second image data comprises the first-type of row image data of the third frame of the first image data.

9. The method for driving a display panel according to claim 8, wherein the generating a second video signal having a second frame rate from the first video signal comprises:
generating the first frame of the second image data from the first-type of row image data in the first frame of the first image data of the first video signal;
generating the second frame of the second image data from the second-type of row image data in the first frame of the first image data;
generating the third frame of the second image data from the second-type of row image data in the second frame of the first image data of the first video signal;
generating the fourth frame of the second image data from the first-type of row image data in the second frame of the first image data;
generating the fifth frame of the second image data from the second-type of row image data in the third frame of the first image data of the first video signal;
generating the sixth frame of the second image data from the first-type of row image data in the third frame of the first image data.

10. The method for driving a display panel according to claim 9, wherein the first video signal comprises a fourth frame of the first image data, a fifth frame of the first image data, and a sixth frame of the first image data to be continuously displayed, the fourth frame of the first image data is image data to be continuously displayed with the third frame of the first image data, the second video signal comprises a seventh frame of the second image data, an eighth frame of the second image data, a ninth frame of the second image data, a tenth frame of the second image data, an eleventh frame of the second image data, and a twelfth frame of the second image data be continuously displayed, the seventh frame of the second image data is image data to be continuously displayed with the sixth frame of the second image data;
the seventh frame of the second image data comprises the first-type of row image data of the fourth frame of the first image data, the eighth frame of the second image data comprises the second-type of row image data of the fourth frame of the first image data, the ninth frame of the second image data comprises the second-type of row image data of the fifth frame of the first image data, the tenth frame of the second image data comprises the first-type of row image data of the fifth frame of the first image data, the eleventh frame of the second image data comprises the second-type of row image data of the sixth frame of the first image data, and the twelfth frame of the second image data comprises the first-type of row image data of the sixth frame of the first image data; and
wherein the generating a second video signal having a second frame rate from the first video signal further comprises:
generating the seventh frame of the second image data from the first-type of row image data in the fourth frame of the first image data of the first video signal;
generating the eighth frame of the second image data from the second-type of row image data in the fourth frame of the first image data;
generating the ninth frame of the second image data from the second-type of row image data in the fifth frame of the first image data of the first video signal;
generating the tenth frame of the second image data from the first-type of row image data in the fifth frame of the first image data;
generating the eleventh frame of the second image data from the second-type of row image data in the sixth frame of the first image data of the first video signal;
generating the twelfth frame of the second image data from the first-type of row image data in the sixth frame of the first image data.

11. A display device, comprising:
a display panel; and
a control chip electrically connected to the display panel, the control chip, wherein the control chip is configured to drive the display panel to display an image according to a method comprising:
receiving a first video signal having a first frame rate;
generating a second video signal having a second frame rate from the first video signal, wherein the second frame rate is greater than the first frame rate;
driving the display panel to display an image according to the second video signal;
wherein the first video signal comprises N frames of first image data to be continuously displayed, the second video signal comprises 2N frames of second image data to be continuously displayed, a (2i−1)th frame of the second image data in the 2N frames of the second image data comprises a first-type of row image data of an i-th frame of the first image data, a 2i-th frame of the second image data in the 2N frames of the second image data comprises a second-type of row image data of the i-th frame of the first image data, a (2i+1)th frame of the second image data in the 2N frames of the second image data comprises the second-type of row image data of an (i+1)th frame of the first image data, and a (2i+2)th frame of the second image data in the 2N frames of the second image data comprises the first-type of row image data of the (i+1)th frame of the first image data;
the first-type of row image data is one of odd-numbered row image data and even-numbered row image data, and the second-type of row image data is another one of the odd-numbered row image data and the even-numbered row image data, N is an integer greater than or equal to 2, i=m*j+1, with i being less than N, m being an integer greater than or equal to 2, and j being an integer greater than or equal to 0.

12. The display device according to claim 11, wherein m=2;
the first video signal comprises a first frame of the first image data and a second frame of the first image data to be continuously displayed, and the second video signal comprises a first frame of the second image data, a second frame of the second image data, a third frame of the second image data, and a fourth frame of the second image data to be continuously displayed;
the first frame of the second image data comprises the first-type of row image data of the first frame of the first image data, the second frame of the second image data comprises the second-type of row image data of the first frame of the first image data, the third frame of the second image data comprises the second-type of row image data of the second frame of the first image data, and the fourth frame of the second image data comprises the first-type of row image data of the second frame of the first image data.

13. The display device according to claim 12, wherein the generating a second video signal having a second frame rate from the first video signal comprises:
generating the first frame of the second image data from the first-type of row image data in the first frame of the first image data of the first video signal;
generating the second frame of the second image data from the second-type of row image data in the first frame of the first image data;
generating the third frame of the second image data from the second-type of row image data in the second frame of the first image data to be continuously displayed with the first frame of the first image data in the first video signal;
generating the fourth frame of the second image data from the first-type of row image data in the second frame of the first image data.

14. The display device according to claim 11, wherein m=3;
a (2i+3)th frame of the second image data in the 2N frames of the second image data comprises the first-type of row image data of a (i+2)th frame of the first image data, and a (2i+4)th frame of the second image data in the 2N frames of the second image data comprises the second-type of row image data of the (i+2)th frame of the first image data.

15. The display device according to claim 14, wherein the first video signal comprises a first frame of the first image data, a second frame of the first image data, and a third frame of the first image data to be continuously displayed, and the second video signal comprises a first frame of the second image data, a second frame of the second image data, a third frame of the second image data, a fourth frame of the second image data, a fifth frame of the second image data, and a sixth frame of the second image data to be continuously displayed;
the first frame of the second image data comprises the first-type of row image data of the first frame of the first image data, the second frame of the second image data comprises the second-type of row image data of the first frame of the first image data, the third frame of the second image data comprises the second-type of row image data of the second frame of the first image data, the fourth frame of the second image data comprises the first-type of row image data of the second frame of the first image data, the fifth frame of the second image data comprises the first-type of row image data of the third frame of the first image data, and the sixth frame of the second image data comprises the second-type of row image data of the third frame of the first image data.

16. The display device according to claim 15, wherein the generating a second video signal having a second frame rate from the first video signal comprises:
generating the first frame of the second image data from the first-type of row image data in the first frame of the first image data of the first video signal;
generating the second frame of the second image data from the second-type of row image data in the first frame of the first image data;
generating the third frame of the second image data from the second-type of row image data in the second frame of the first image data of the first video signal;
generating the fourth frame of the second image data from the first-type of row image data in the second frame of the first image data;
generating the fifth frame of the second image data from the first-type of row image data in the third frame of the first image data of the first video signal;
generating the sixth frame of the second image data from the second-type of row image data in the third frame of the first image data.

17. The display device according to claim 11, wherein m=3;
a (2i+3)th frame of the second image data in the 2N frames of the second image data comprises the second-type of row image data of a (i+2)th frame of the first image data, and a (2i+4)th frame of the second image data in the 2N frames of the second image data comprises the first-type of row image data of the (i+2)th frame of the first image data.

18. The display device according to claim 17, wherein the first video signal comprises a first frame of the first image data, a second frame of the first image data, and a third frame of the first image data to be continuously displayed, and the second video signal comprises a first frame of the second image data, a second frame of the second image data, a third frame of the second image data, a fourth frame of the second image data, a fifth frame of the second image data, and a sixth frame of the second image data to be continuously displayed;
the first frame of the second image data comprises the first-type of row image data of the first frame of the first image data, the second frame of the second image data comprises the second-type of row image data of the first frame of the first image data, the third frame of the second image data comprises the second-type of row image data of the second frame of the first image data, the fourth frame of the second image data comprises the first-type of row image data of the second frame of the first image data, the fifth frame of the second image data comprises the second-type of row image data of the third frame of the first image data, and the sixth frame of the second image data comprises the first-type of row image data of the third frame of the first image data.

19. The display device according to claim 18, wherein the generating a second video signal having a second frame rate from the first video signal comprises:
generating the first frame of the second image data from the first-type of row image data in the first frame of the first image data of the first video signal;
generating the second frame of the second image data from the second-type of row image data in the first frame of the first image data;
generating the third frame of the second image data from the second-type of row image data in the second frame of the first image data of the first video signal;
generating the fourth frame of the second image data from the first-type of row image data in the second frame of the first image data;
generating the fifth frame of the second image data from the second-type of row image data in the third frame of the first image data of the first video signal;
generating the sixth frame of the second image data from the first-type of row image data in the third frame of the first image data.

20. The display device according to claim 19, wherein the first video signal comprises a fourth frame of the first image data, a fifth frame of the first image data, and a sixth frame of the first image data to be continuously displayed, the fourth frame of the first image data is image data to be continuously displayed with the third frame of the first image data, the second video signal comprises a seventh frame of the second image data, an eighth frame of the second image data, a ninth frame of the second image data, a tenth frame of the second image data, an eleventh frame of the second image data, and a twelfth frame of the second image data be continuously displayed, the seventh frame of the second image data is image data to be continuously displayed with the sixth frame of the second image data;
the seventh frame of the second image data comprises the first-type of row image data of the fourth frame of the first image data, the eighth frame of the second image data comprises the second-type of row image data of the fourth frame of the first image data, the ninth frame of the second image data comprises the second-type of row image data of the fifth frame of the first image data, the tenth frame of the second image data comprises the first-type of row image data of the fifth frame of the first image data, the eleventh frame of the second image data comprises the second-type of row image data of the sixth frame of the first image data, and the twelfth frame of the second image data comprises the first-type of row image data of the sixth frame of the first image data; and
wherein the generating a second video signal having a second frame rate from the first video signal further comprises:
generating the seventh frame of the second image data from the first-type of row image data in the fourth frame of the first image data of the first video signal;
generating the eighth frame of the second image data from the second-type of row image data in the fourth frame of the first image data;
generating the ninth frame of the second image data from the second-type of row image data in the fifth frame of the first image data of the first video signal;
generating the tenth frame of the second image data from the first-type of row image data in the fifth frame of the first image data;
generating the eleventh frame of the second image data from the second-type of row image data in the sixth frame of the first image data of the first video signal;
generating the twelfth frame of the second image data from the first-type of row image data in the sixth frame of the first image data.
